(19) United States
(12) Patent Application Publication
(10) Pub. No.: US 2011/0100148 A1
(43) Pub. Date: May 5, 2011

(54) CRASH ENERGY ABSORBING MOUNTING BRACKET AND STEERING COLUMN OF VEHICLE HAVING THE SAME

(75) Inventor: Sung Joon JUNG, (US)

(73) Assignee: MANDO CORPORATION

(21) Appl. No.: 12/912,226

(22) Filed: Oct. 26, 2010

(30) Foreign Application Priority Data
Oct. 29, 2009 (KR) 10-2009-0103461
Oct. 11, 2010 (KR) 10-2010-0098608

(51) Int. Cl. B62D 1/16

(52) U.S. Cl. 74/492; 280/779

(57) ABSTRACT

A crash energy absorbing mounting bracket and a steering column having the same of a vehicle are disclosed. The mounting bracket of the steering column is tilted without a separated tilting part and absorbs crash energy generated by the collision of a vehicle. Thus, safety is improved when the vehicle collides and the number of parts and manufacturing and assembly processes may be reduced.

### CROSS-REFERENCE TO RELATED APPLICATION

This application claims priority from and the benefit of Korean Patent Application No. 10-2009-0103461, filed on Oct. 29, 2009 and Korean Patent Application No. 10-2010-0098608, Oct. 11, 2010, which are hereby incorporated by reference for all purposes as if fully set forth herein.

### BACKGROUND OF THE INVENTION

1. Field of the Invention

The present invention relates to a crash energy absorbing mounting bracket and a steering column of a vehicle having the same. More particularly the present invention relates to a crash energy absorbing mounting bracket for being tilted without a separated tilting part and for absorbing crash energy when a vehicle collides to improve safety of the vehicle and to reduce the number of parts and manufacturing and assembly processes, and a vehicle steering column having the same.

2. Description of the Prior Art

As generally known in the art, a steering system of a vehicle is a device for allowing a driver to change the traveling direction of the vehicle as the driver's will and for assisting the driver to change a turning point around which front wheels of the vehicle turn arbitrary and drives the vehicle in the direction where the driver desires to drive the vehicle. In the steering system of a vehicle, steering force generated by which the driver rotates a steering wheel is transmitted to a rack-and-pinion mechanism via a steering shaft of the steering column and finally changes a traveling direction of both front wheels.

Moreover, the steering system of a vehicle may have expanded functions, such as a telescopic function and/or tilting function, added to the steering column for the user's convenience, wherein a tilt device is to adjust a fixed angle of the steering wheel and the telescopic device is configured by inserting two hollow tubes to be elongated or shrunk in the shaft direction and has a function of absorbing crash energy while the steering shaft and the steering column are collapsed when the vehicle crashes.

Steering columns are classified into a normal steering column without the expanded functions and a telescopic steering column or a tilting steering column according to the expanded functions, and as occasion demands the telescopic steering column may further have the tilt function. With the expanded functions, the driver adjusts length or a tilt angle of the steering wheel suitable for the driver's height and body type so as to steer a vehicle easily and conveniently.

FIG. 1 is a view schematically illustrating a normal steering system of a vehicle. In the normal steering system of a vehicle, a lower end of a steering shaft 130 is connected to a gearbox 180. Since the steering shaft 130 is designed to be connected to the gearbox 180 in a state of being inclined by a certain angle due to the structural condition of a vehicle, the steering shaft 130, in order to satisfy the condition, is connected through a universal joint and uses an intermediate shaft having a tube 100 and a shaft 110.

The intermediate shaft 120 a side of which is connected to the steering shaft 130 connected to the steering wheel 170 and the other side of which is connected to the gearbox 180 transmits a rotational force generated by the steering wheel 170 to wheels through the gearbox 180.

The steering column 150 includes a column tube 147, an upper mounting bracket 160, and a lower mounting bracket 165. The column tube 147 may include an outer tube 145 and an inner tube 140. The outer tube 145 is provided at a side of the steering wheel 170 and the inner tube 140 is provided in the outer tube 145 and has a diameter smaller than that of the outer tube 145 so that the inner tube 140 slides into the outer tube 145 when an impact is applied. The outer tube 145 and the inner tube 140 are formed in the form of hollow tubes to allow the steering shaft 130 to smoothly rotate.

A dust cover 105 is fixed to a dash panel 115 and is used to block noise entering a compartment through an engine room.

However, in order to add the tilting function to the existing normal steering system of a vehicle, a separated part for rotating and supporting the steering column, in addition to the upper mounting bracket and the lower mounting bracket, must be fabricated and assembled.

Moreover, another separated part for absorbing crash energy must be fabricated and assembled in order to absorb the crash energy generated when a vehicle crashes and to protect a driver.

### SUMMARY OF THE INVENTION

Accordingly, the present invention has been made to solve the above-mentioned problems occurring in the prior art, and an object of the present invention is to provide a crash energy absorbing mounting bracket for being tilted without a separated tilting part and for absorbing crash energy when a vehicle collides to improve the safety of the vehicle and to reduce the number of parts and manufacturing and assembly processes, and a vehicle steering column having the same.

In order to accomplish this object, there is provided a crash energy absorbing mounting bracket including: a column bracket including a first plate having a column penetrating hole formed at the center thereof through which a steering column penetrates and a second plate having an intermediate shaft penetrating hole, formed at the center thereof by bending an end of the first plate, through which an end of the first plate penetrates, the first plate having a reinforcing plate formed by bending an end of the second plate and coupling plates formed by bending both ends of the second plate to face each other; and a hinge bracket having supporting plates rotatably coupled to sides of the coupling plates and bent fixing plates fixing the supporting plates to a vehicle body.

In accordance with another aspect of the present invention, there is provided a steering column including: a steering shaft connected to a steering wheel; the above-mentioned crash energy absorbing mounting bracket; a column tube in which the steering shaft is rotatably installed and with which the crash energy absorbing mounting bracket is coupled; and an upper mounting bracket coupled to the column tube to fix the steering column to the vehicle body.

In accordance with still another aspect of the present invention, there is provided a crash energy absorbing mounting bracket including: a first plate having a column penetrating hole formed at the center through which a steering column penetrates; a second plate formed by bending an end of the first plate and having an intermediate shaft penetrating hole formed at the center through which an intermediate shaft penetrates; and a hinge plate including a connector formed by bending an end of the second plate and a support formed by bending the connector and having ends to face each other.

In accordance with still another aspect of the present invention, there is provided a steering column of a vehicle including: a steering shaft connected to a steering wheel; the above-mentioned crash energy absorbing mounting bracket; a column tube in which the steering shaft is rotatably coupled and with which the crash energy absorbing mounting bracket is coupled; and an upper mounting bracket coupled to the column tube to fix the steering column to the vehicle body.

According to the present invention, the mounting bracket of the steering column may be tilted without a separated tilting part and absorb crash energy generated when a vehicle crashes so that safety against the collision and crash of a vehicle may be improved and the number of parts and manufacturing and assembly processes may be reduced.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view illustrating a steering system of a normal vehicle;

FIG. 2 is a perspective view illustrating a crash energy absorbing mounting bracket according to an embodiment of the present invention;

FIGS. 3 and 4 are a front view and a plan view illustrating the crash energy absorbing mounting bracket according to the embodiment of the present invention;

FIG. 5 is a side view illustrating a steering column having the crash energy absorbing mounting bracket according to the embodiment of the present invention;

FIG. 6 is a perspective view illustrating a crash energy absorbing mounting bracket according to another embodiment of the present invention;

FIG. 7 is a perspective view illustrating a hinge tube and a bush of the crash energy absorbing mounting bracket according to another embodiment of the present invention;

FIGS. 8 and 9 are a front view and a side view illustrating the crash energy absorbing mounting bracket according to another embodiment of the present invention; and

FIG. 10 is a side view illustrating a steering column having the crash energy absorbing mounting bracket according to another embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

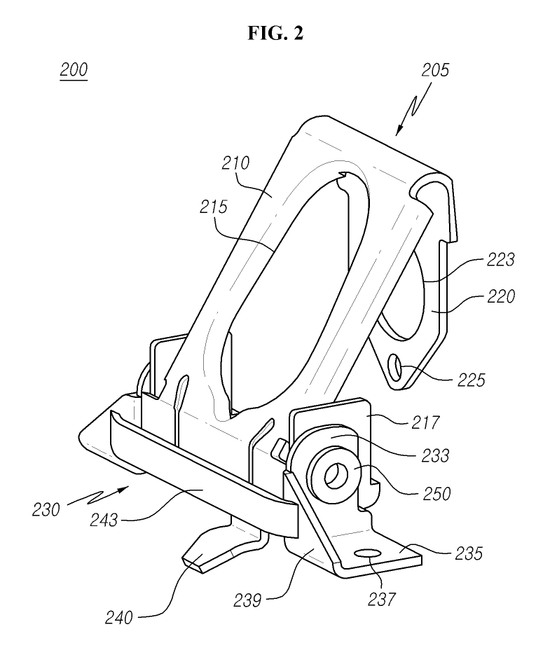

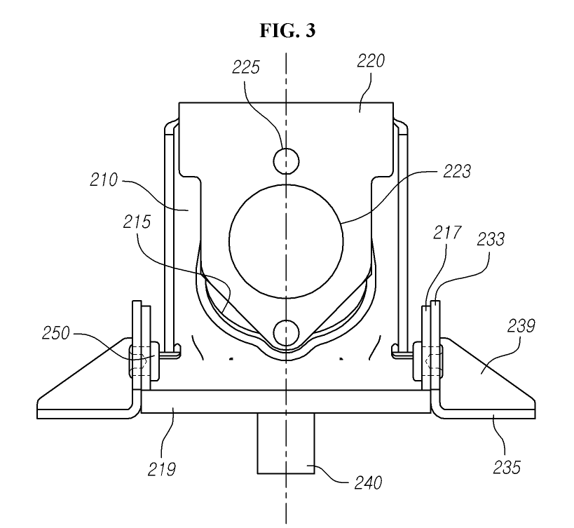

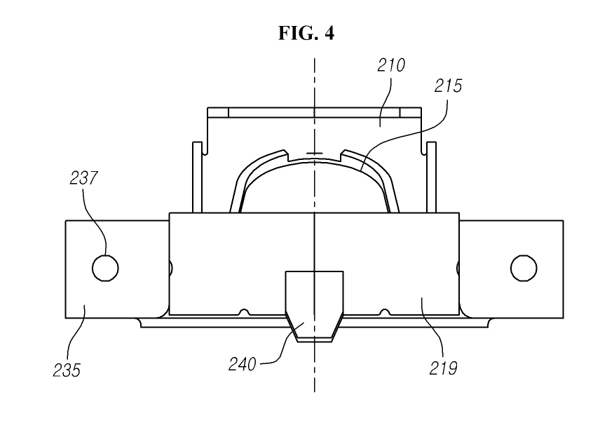

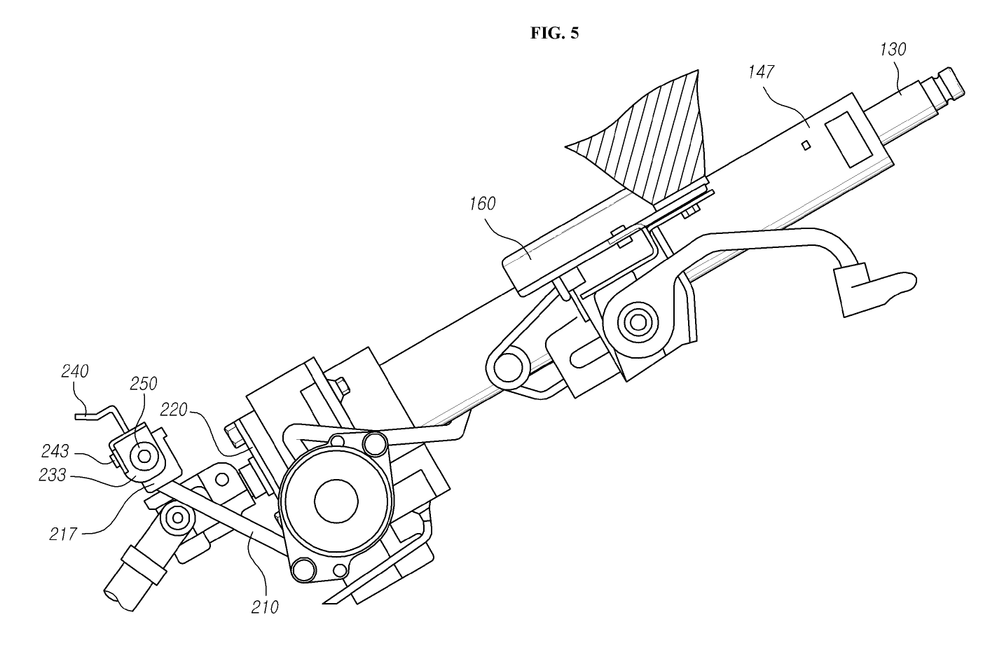

FIG. 2 is a perspective view illustrating a crash energy absorbing mounting bracket according to an embodiment of the present invention. FIGS. 3 and 4 are a front view and a plan view illustrating the crash energy absorbing mounting bracket according to the embodiment of the present invention. FIG. 5 is a side view illustrating a steering column having the crash energy absorbing mounting bracket according to the embodiment of the present invention.

As illustrated in the drawings, a crash energy absorbing mounting bracket 200 according to an embodiment of the present invention includes: a column bracket 205 having a first plate 220 having a column penetrating hole 223, formed at the center thereof, through which a steering column penetrates, a second plate 210 formed by bending an end of the first plate 220 and having an intermediate shaft penetrating hole 215 formed at the center thereof through which an intermediate shaft penetrates, a reinforcing plate 219 formed by bending an end of the second plate 210, and coupling plates 217 formed by bending the second plate 210 to face each other; and a hinge bracket 230 having supporting plates 233 which are pivotally coupled with sides of the coupling plates 217 and have fixing bending plates 235 fixed to a vehicle body.

The crash energy absorbing mounting bracket 200 according to the embodiment of the present invention performs a tilt operation of the steering column to allow a normal steering column to be tilted and absorbs crash energy of a vehicle.

The crash energy absorbing mounting bracket 200 according to the embodiment of the present invention generally includes the column bracket 205 mounted to the steering column to support the steering column and the hinge bracket 230 pivotally coupled to the column bracket 205 to be tilted and to fix the steering column to the vehicle body.

The column bracket 205 includes the first plate 220 coupled to the steering column and having the column penetrating hole 223 formed at the center through which the steering column penetrates and the second plates 210 formed by bending the end of the first plate 220 and having the intermediate shaft penetrating hole 215 formed at the center through which the intermediate shaft penetrates.

The first plate 220 and the second plate 210 are bent by a predetermined angle such that the column penetrating hole 223 communicates with the intermediate shaft penetrating hole 215 and the steering column and the intermediate shaft connected to the lower side of the steering column with a universal joint extending through the hole 223 and 215 to be coupled with each other, and then are driven for the steering.

Moreover, the first plate 220 coupled to the steering column has column coupling holes 225 formed around the column penetrating hole 223 through which the steering column is coupled with screws or bolts.

The second plate 210 includes the reinforcing plate 219 with a bent end and the coupling plates 217 formed by bending both sides of the reinforcing plate 219 to face each other in parallel, so that the second plate 210 is supported by and pivoted around the later-described hinge bracket 230 to perform the tilt operation.

The first plate 220 and the second plate 210 bent by a preset angle absorb crash energy when a vehicle crashes or collides with obstacle such that the first plate 220 coupled with the steering column receives a force applying to the front side of the vehicle, that is, the second plate 210 and the second plate 210 coupled with the vehicle body via the hinge bracket 230 receives a force applying to the rear side of the vehicle, that is, the first plate 220, resulting in plastic deformation of the first plate 220 and the second plate 210 being folded.

Meanwhile, the hinge bracket 230 coupled with the column bracket 205 has the supporting plates 233 closely coupled with both sides of the coupling plates 217 spaced apart from each other so that the hinge bracket 230 is pivotally coupled with the coupling plates 217.

The coupling plates 217 and the supporting plates 233 are coupled with each other by hinge members 250 such as rivets, pins, bolts, or the like for allowing rotation so that the column bracket 205 connected to the steering column may be tilted with the hinge bracket 230.

Each of the supporting plates 233 has the fixing plate 235 bent perpendicular to a direction where a width is widening from a surface of the supporting plate 233 and fixed to the vehicle body and a reinforcing rib 239 connecting the fixing plate 235 to a corner of the supporting plate 233.

The fixing plates 235 have body fixing holes 237 to be coupled to the vehicle body with screws or bolts.

Thus, the hinge bracket 230 is fixed to the vehicle body to support the load of the steering column and the column bracket 205 coupled with the steering column pivots around the hinge members 250 so that the steering column may be tilted.

Moreover, the hinge bracket 230 may be configured by integrally connecting the reinforcing ribs 239 that are spaced apart from each other to each other by a connection plate 243. The integrated hinge bracket 230 has enhanced strength and the assembly processes may be reduced.

The second reinforcing plate 219 of the second plate 210 has a seat plate 240 seated and supported in a hole of the vehicle body during the assembling of the steering column so that the steering column may be easily assembled to the vehicle body.

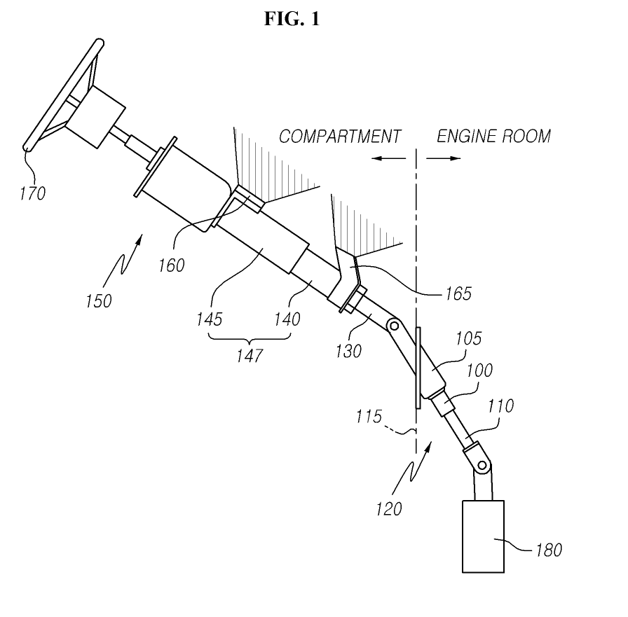

The crash energy absorbing mounting bracket 200 according to the embodiment of the present invention is coupled with a steering shaft 130 connected to a steering wheel 170 (See FIG. 1), a column tube 147, into which the steering shaft 130 is inserted to rotate, coupled with the crash energy absorbing mounting bracket 200, and an upper mounting bracket 160 coupled to the column tube 147 and fixing the steering column to the vehicle body, so that the steering column of a vehicle is configured.

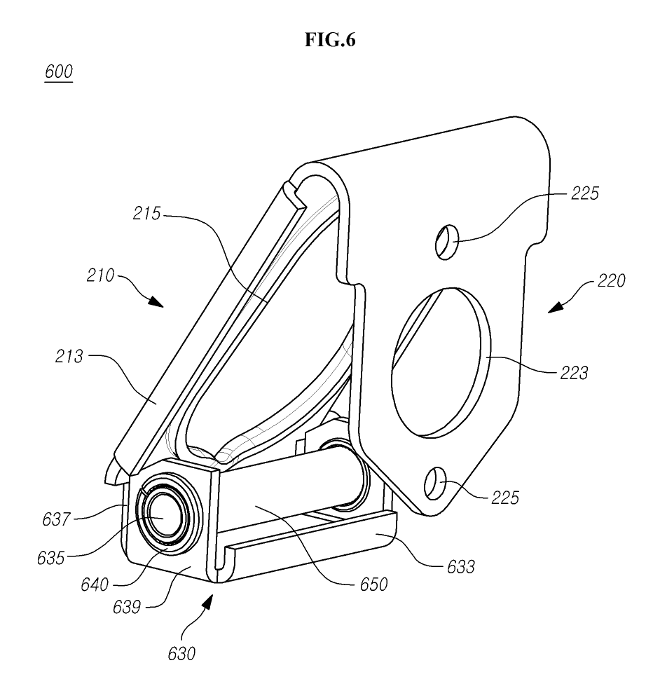

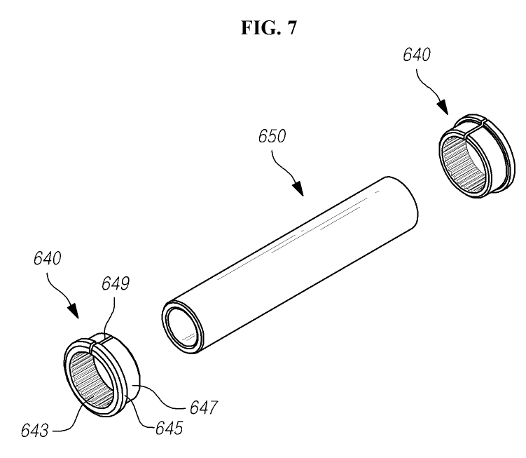

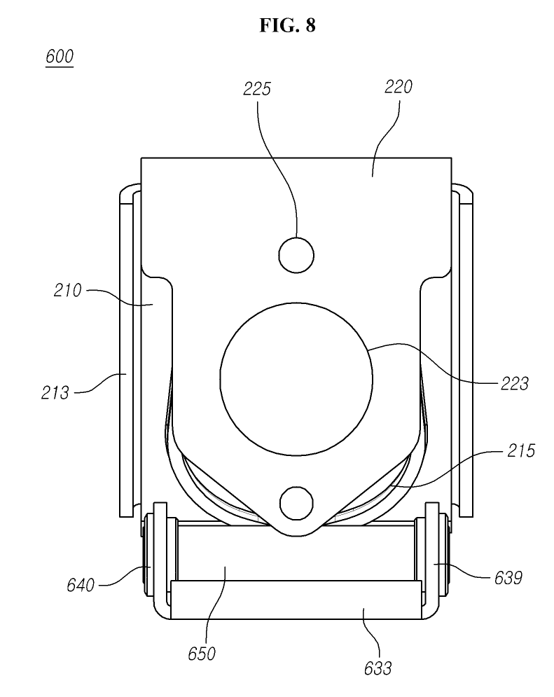

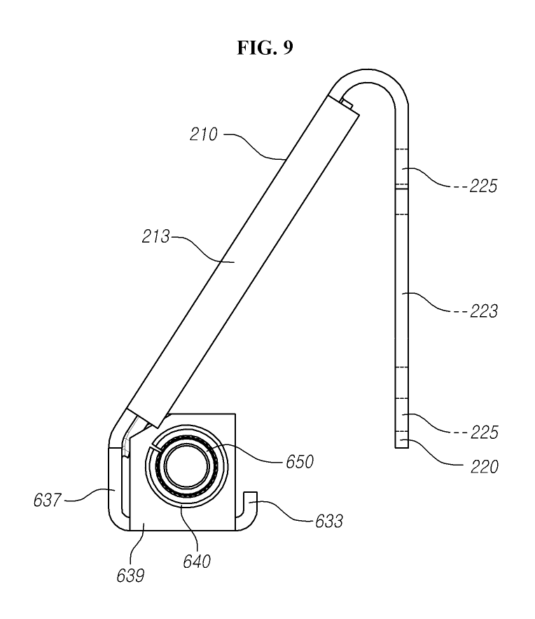

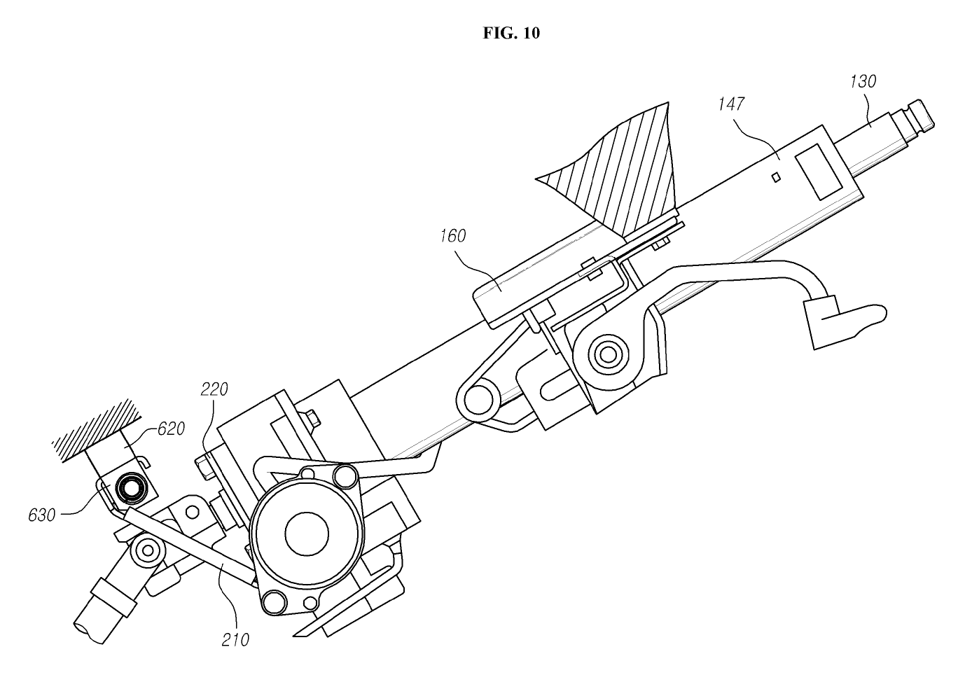

FIG. 6 is a perspective view illustrating a crash energy absorbing mounting bracket according to another embodiment of the present invention. FIG. 7 is a perspective view of a hinge tube and a bush of the crash energy absorbing mounting bracket according to another embodiment of the present invention. FIGS. 8 and 9 are a front view and a side view illustrating the crash energy absorbing mounting bracket according to another embodiment of the present invention. FIG. 10 is a side view illustrating a steering column having the crash energy absorbing mounting bracket according to another embodiment of the present invention.

As illustrated in the drawings, a crash energy absorbing mounting bracket 600 according to another embodiment of the present invention includes a first plate 220 having a column penetrating hole 223, formed at the center thereof, through which a steering column penetrates, a second plate 210 formed by bending an end of the first plate 220 and having an intermediate shaft penetrating hole 215, formed at the center, through which an intermediate shaft penetrates, and a hinge plate 630 having a connector 637 formed by bending an end of the second plate 210 and a support 639 formed by bending the connector 637 such that ends thereof face each other.

The crash energy absorbing mounting bracket 600 according to another embodiment of the present invention performs a tilt operation and absorbs crash energy of a vehicle such that the steering column may be assembled with a vehicle body 620 and may be tilted.

The crash energy absorbing mounting bracket 600 is roughly made by integrally bending the first plate 220, the second plate 210, and the hinge plate 630 and is rotatably coupled to the vehicle body 620.

The first plate 220 has a column penetrating hole 223 formed at the center through which the steering column penetrates and a column coupling hole. The second plate 210 formed by bending an end of the first plate 220 has an intermediate shaft penetrating hole 215 formed at the center through which an intermediate shaft penetrates. The hinge plate 630 formed by bending an end of the second plate 210 is rotatably coupled to the vehicle body 620.

The first plate 220 and the second plate 210 are bent by approximately 20 degrees to 70 degrees such that the column penetrating hole 223 and the intermediate shaft penetrating hole 215 are communicated with each other and that the steering column and the intermediate shaft connected to the lower side by a universal joint penetrate the first plate 220 and the second plate.

The first plate 220 coupled to the steering column has a column coupling hole 225 such that the steering column may be coupled around the column penetrating hole 223 with screws or bolts.

The second plate 210 has the intermediate shaft penetrating hole 215 and the second plate 210 includes reinforcing flanges 213 formed by bending both ends of the second plate 210 by a preset angle against surfaces of the second plate 210 to reinforce the strength of the mounting bracket 213 assembled to the vehicle body 620.

The first plate 220 and the second plate 210 bent by a preset angle absorb crash energy when a vehicle crashes or collides with obstacle such that the first plate 220 coupled with the steering column receives a force applying to the front side of the vehicle, that is, the second plate 210 and the second plate 210 coupled with the vehicle body 620 via the hinge plate 630 receives a force applying to the rear side of the vehicle, that is, the first plate 220, resulting in plastic deformation of the first plate 220 and the second plate 210 being folded.

The hinge plate 630 is formed by bending an end of the second plate 210 and is coupled with the vehicle body 620 to enable the steering column to be tilted.

The hinge plate 630 includes the connector 637 formed by bending an end of the second plate 210 and the support 639 formed by bending the connector 637 such that both ends face each other. The support 639 has hinge holes 635 through which the steering column penetrated in a tilt shaft direction such that the hinge plate 630 may be rotatably coupled with the vehicle body 620 by coupling members.

The connector 637 of the hinge plate 630 is formed by bending the end of the first plate 220 approximately by 10 degrees to 50 degrees toward the first plate 220 and the support 639 formed by bending the connector 637 is formed such that both ends face each other in the tilt shaft direction.

The support 639 both ends of which face each other has the hinge hole 635 and the mounting bracket 600 is coupled to the vehicle body 620 penetrating the hinge hole 635 by coupling members serving as a tilt shaft.

Here, the coupling members include bolts and nuts fastening both sides of the support 639 and the bolts serve as the tilt shaft when the steering column is tilted.

A reinforcing unit 633 is formed by bending an end of the support by a preset angle and reinforces the strength of the hinge plate 630 when the steering column is tilted.

A hollow pipe-shaped hinge tube 650 is coupled with the hinge hole 635 of the support 639 to be coupled with the vehicle body 620 by coupling members penetrating the hinge tube 650 and bushes 640 may be coupled between the hinge hole 635 and the hinge tube 650.

Each of the bushes 640 includes a body 647 inserted into the hinge hole 635, a large diameter portion 647 expanded from the body 647 to have an enlarged diameter and preventing the bush 640 from being separated from the hinge hole 635, and an unevenness 643 reducing a pressure when the hinge tube 650 is press-fitted.

As such, when the hinge tube 650 is coupled with the hinge holes 635 by means of the bushes 640, the bushes 640 serve as a tilt shaft while being rotated within the hinge holes 635 and the mounting bracket 600 is coupled with the vehicle body 620 by the coupling members having bolts and nuts.

Each of the bushes 640 has a cut-off portion 649 cut off from the inner circumference to the outer circumference in the longitudinal direction so the bush 640 is securely coupled within the hinge hole 635 by an elastic force of the bush 640 applying in the circumferential direction when the bush 640 is coupled within the hinge hole 635.

Since abrasion resistance, low friction, preset bending force, strength, and low expansion due to heat are required, the bushes 640 are made of engineering plastic material such as polyacetal (POM), polyamide (PA), polycarbonate (PC), polyimide (PI), and polybutylene terephthalate (PBT).

Meanwhile, the above-mentioned crash energy absorbing mounting bracket 600 includes a steering shaft 130 connected to the steering wheel 170 (See FIG. 1), a column tube 147 rotatably installed in the steering shaft 130 to which the crash energy absorbing mounting bracket 600 is coupled, and an upper mounting bracket 160 coupled with the column tube 147 to fix the steering column to the vehicle body so as to form the steering column of a vehicle.

According to the crash energy absorbing mounting bracket having the above-mentioned structure and shape of the present invention, the crash energy absorbing mounting bracket may be tilted without a separated tilting part and may absorb crash energy generated by a collision of the vehicle so that the safety of the vehicle against collision is improved and the number of parts and manufacturing and assembly processes may be reduced.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

What is claimed is:

1. A crash energy absorbing mounting bracket comprising:
a column bracket including a first plate having a column penetrating hole formed at the center thereof through which a steering column penetrates and a second plate having an intermediate shaft penetrating hole, formed at the center thereof by bending an end of the first plate, through which an end of the first plate penetrates, the first plate having a reinforcing plate formed by bending an end of the second plate and coupling plates formed by bending both ends of the second plate to face each other; and
a hinge bracket having supporting plates rotatably coupled to sides of the coupling plates and bent fixing plates fixing the supporting plates to a vehicle body.

2. The crash energy absorbing mounting bracket as claimed in claim 1, wherein the hinge bracket includes reinforcing ribs connecting the supporting plates to corners of the fixing plates.

3. The crash energy absorbing mounting bracket as claimed in claim 2, wherein the hinge bracket is integrally formed by a connecting plate connecting the reinforcing ribs spaced apart from each other.

4. The crash energy absorbing mounting bracket as claimed in claim 1, wherein the second plate further includes a seat plate seated in and supported by a hole of the vehicle body when the steering column is assembled.

5. A steering column comprising:
a steering shaft connected to a steering wheel;
a crash energy absorbing mounting bracket including:
a column bracket including a first plate having a column penetrating hole formed at the center thereof through which a steering column penetrates and a second plate having an intermediate shaft penetrating hole, formed at the center thereof by bending an end of the first plate, through which an end of the first plate penetrates, the first plate having a reinforcing plate formed by bending an end of the second plate and coupling plates formed by bending both ends of the second plate to face each other; and
a hinge bracket having supporting plates rotatably coupled to sides of the coupling plates and bent fixing plates fixing the supporting plates to a vehicle body;
a column tube in which the steering shaft is rotatably installed and with which the crash energy absorbing mounting bracket is coupled; and
an upper mounting bracket coupled to the column tube to fix the steering column to the vehicle body.

6. A crash energy absorbing mounting bracket comprising:
a first plate having a column penetrating hole formed at the center through which a steering column penetrates;
a second plate formed by bending an end of the first plate and having an intermediate shaft penetrating hole formed at the center through which an intermediate shaft penetrates; and
a hinge plate including a connector formed by bending an end of the second plate and a support formed by bending the connector and having ends to face each other.

7. The crash energy absorbing mounting bracket as claimed in claim 6, wherein the support has a hinge hole through which the steering column penetrates toward a tilt shaft.

8. The crash energy absorbing mounting bracket as claimed in claim 7, wherein a hollow hinge tube is coupled within the hinge hole such that the crash energy absorbing mounting bracket is rotatably coupled to the vehicle body by coupling members penetrating the hinge tube.

9. The crash energy absorbing mounting bracket as claimed in claim 8, wherein a bush is coupled between the hinge hole and the hinge tube.

10. The crash energy absorbing mounting bracket as claimed in claim 9, wherein the bush has an unevenness formed on an inner circumference through which the hinge tube is inserted.

11. The crash energy absorbing mounting bracket as claimed in claim 9, wherein the bush has a cut-off portion cut off from the inner circumference to an outer circumference.

12. The crash energy absorbing mounting bracket as claimed in claim 6, wherein the support includes a reinforcing unit formed by bending an end of the support by a preset angle.

13. The crash energy absorbing mounting bracket as claimed in claim 1, wherein the second plate includes reinforcing flanges formed by bending both ends of the second plate by a preset angle.

14. A steering column of a vehicle comprising:
a steering shaft connected to a steering wheel;
a crash energy absorbing mounting bracket including:
a first plate having a column penetrating hole formed at the center through which a steering column penetrates;
a second plate formed by bending an end of the first plate and having an intermediate shaft penetrating hole formed at the center through which an intermediate shaft penetrates; and
a hinge plate including a connector formed by bending an end of the second plate and a support formed by bending the connector and having ends to face each other;
a column tube in which the steering shaft is rotatably coupled and with which the crash energy absorbing mounting bracket is coupled; and
an upper mounting bracket coupled to the column tube to fix the steering column to the vehicle body.
